(19) United States
(12) Patent Application Publication
(10) Pub. No.: US 2026/0164458 A1
(43) Pub. Date: Jun. 11, 2026

(54) METHODS AND APPARATUSES FOR PHYSICAL DOWNLINK SHARED CHANNEL RECEPTION

(71) Applicant: Lenovo (Beijing) Limited, Beijing (CN)

(72) Inventors: Yu Zhang, Beijing (CN); Haipeng Lei, Beijing (CN); Bingchao Liu, Beijing (CN)

(73) Assignee: Lenovo (Beijing) Limited, Beijing (CN)

(21) Appl. No.: 18/706,365

(22) PCT Filed: Nov. 5, 2021
(86) PCT No.: PCT/CN2021/129075

§ 371 Date: Apr. 30, 2024

(51) Int. Cl. H04W 74/0808; H04L 1/1829; H04W 72/044; H04W 72/20

(52) U.S. Cl. CPC H04W 74/0808; H04L 1/1854; H04W 72/046; H04W 72/20

(57) ABSTRACT

Various aspects of the present disclosure relate to physical downlink shared channel reception. An apparatus, such as a user equipment (UE) receives at least one downlink control information (DCI) from a base station (BS) scheduling the UE to receive a first set of physical downlink shared channels (PDSCHs) associated with at least two transmission configuration indication (TCI) states and to transmit a physical uplink control channel (PUCCH). The UE receives a second set of PDSCHs and generating HARQ feedback(s) corresponding to the second set of PDSCHs. The UE determines an uplink (UL) transmission (Tx) beam of at least two UL Tx beams, wherein the determined UL Tx beam is associated with a sensing beam where listen-before-transmit (LBT) procedures generate a success result. The UE transmits the PUCCH carrying the HARQ feedback(s) corresponding to the second set of PDSCHs with the determined UL Tx beam.

### TECHNICAL FIELD

The present disclosure generally relates to wireless communication technologies, and especially to methods and apparatuses for Hybrid Automatic Repeat Request (HARQ) feedback for a User Equipment (UE) on unlicensed bands.

### BACKGROUND OF THE INVENTION

For network of 3GPP (3^{rd} Generation Partnership Project) 5G NR (New Radio), technologies of data transmission on unlicensed bands are developed. When unlicensed bands are used by a device, for example a base station (BS) or a user equipment (UE) for data transmission(s), channel access procedures (e.g., Listen-Before-Talk procedures, LBT procedures) may be required to be performed by the device. The LBT procedures are executed by performing energy detection on a certain channel. Only when the LBT procedures generate a success result can the device initiates data transmission(s) on the certain channel, and this is also called the initiating device initiates a channel occupancy (CO). Then another device which receives the data from the initiating device and is known as a responding device can also perform data transmission(s) to the initiating device on the certain channel, and this is also called the responding device shares the CO. The CO refers to all the data transmission(s) between the initiating device and the responding device(s). These data transmission(s) can occupy the channel for a duration of time, which is known as a time duration of the CO or a COT (channel occupancy time) and is up to a maximum channel occupancy time (MCOT).

Conventional omni-directional LBT procedures may cause some issues when operated on the unlicensed bands around 60 GHz, of which the biggest one is over protection. To improve the probability of successful channel access and to enhance the spatial reuse, directional LBT procedures, which are executed by performing energy detection with one or more sensing beams, are introduced. The one or more sensing beams may also be referred to as LBT beams. According to the results generated by the LBT procedures with one or more sensing beams, the initiating device and the responding device(s) can determine a spatial region, and a transmission (Tx) beam used by the initiating device and the responding device(s) to perform a transmission on the channel within the COT should be within the spatial region, that is, the one or more sensing beams should cover the Tx beam.

### SUMMARY

Various embodiments and methods of the present disclosure provide solutions related to HARQ feedback transmission on unlicensed bands.

According to some embodiments of the present disclosure, an exemplary method performed by a UE is provided. The method includes: receiving at least one DCI from a BS scheduling the UE to receive a first set of PDSCHs associated with at least two transmission configuration indication (TCI) states and to transmit a PUCCH; receiving a second set of PDSCHs and generating HARQ feedback(s) corresponding to the second set of PDSCHs; determining a UL Tx beam of at least two UL Tx beams, wherein the determined UL Tx beam is associated with a sensing beam where LBT procedures generate a success result; and transmitting the PUCCH carrying the HARQ feedback(s) corresponding to the second set of PDSCHs with the determined UL Tx beam.

In some embodiments, the LBT procedures are performed by the BS with at least two downlink (DL) sensing beams including the sensing beam where LBT procedures generate a success result, and the PUCCH is transmitted within a time duration of a CO initiated by the BS.

In some embodiments, the LBT procedures are performed by the UE with at least two UL sensing beams including the sensing beam where LBT procedures generate a success result, and the PUCCH is transmitted within a time duration of a CO initiated by the UE.

In some embodiments, the at least two UL Tx beams are indicated to be associated with the PUCCH by higher layer signaling.

In some embodiments, the high layer signaling indicates spatial relation between at least two reference signals (RSs) and the PUCCH, wherein each of the at least two RSs is a synchronization signal block (SSB), CSI-RS, or SRS.

In some embodiments, receiving the at least one DCI scheduling the UE to receive the first set of PDSCHs and to transmit the PUCCH further includes receiving a single DCI, wherein the single DCI indicates at least two groups of demodulation reference signal (DMRS) ports and the at least two TCI states for the reception of the first set of PDSCHs.

In some embodiments, receiving the at least one DCI scheduling the UE to receive the first set of PDSCHs and to transmit the PUCCH further includes receiving at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the HARQ feedback(s) corresponding to the corresponding subset of the first set of PDSCHs.

In some embodiments, each of the at least one DCI indicates the same at least two candidate PUCCHs, wherein each candidate PUCCH of the at least two candidate PUCCHs is indicated to correspond to a separate UL Tx beam of the at least two UL Tx beams by higher layer signaling.

In some embodiments, the method further includes determining a PUCCH of the at least two candidate PUCCHs to be the PUCCH carrying the HARQ feedback(s) corresponding to the second set of PDSCHs, wherein the determined UL Tx beam corresponds to the determined PUCCH.

In some embodiments, receiving the at least one DCI scheduling the UE to receive the first set of PDSCHs and to transmit the PUCCH further includes receiving a single DCI, wherein the single DCI indicates at least two groups of DMRS ports and the at least two TCI states for the reception of the first set of PDSCHs.

In some embodiments, receiving the at least one DCI scheduling the UE to receive the first set of PDSCHs and to transmit the PUCCH further includes receiving at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the HARQ feedback(s) corresponding to the corresponding subset of the first set of PDSCHs.

According to some embodiments of the present disclosure, an exemplary UE is provided. The UE includes a processor and a wireless transceiver coupled to the processor, the processor is configured to receive, with the wireless transceiver, at least one DCI from a BS scheduling the UE to receive a first set of PDSCHs associated with at least two TCI states and to transmit a PUCCH; receive, with the wireless transceiver, a second set of PDSCHs and generating HARQ feedback(s) corresponding to the second set of PDSCHs; determine a UL Tx beam of at least two UL Tx beams, wherein the determined UL Tx beam is associated with a sensing beam where LBT procedures generate a success result; and transmit, with the wireless transceiver, the PUCCH carrying the HARQ feedback(s) corresponding to the second set of PDSCHs with the determined UL Tx beam.

In some embodiments, the LBT procedures are performed by the base station (BS) with at least two DL sensing beams including the sensing beam where LBT procedures generate a success result, and the PUCCH is transmitted within a time duration of a CO initiated by the BS.

In some embodiments, the LBT procedures are performed by the UE with at least two UL sensing beams including the sensing beam where LBT procedures generate a success result, and the PUCCH is transmitted within a time duration of a CO initiated by the UE.

In some embodiments, the at least two UL Tx beams are indicated to be associated with the PUCCH by higher layer signaling.

In some embodiments, the high layer signaling indicates spatial relation between at least two RSs and the PUCCH, wherein each of the at least two RSs is an SSB, CSI-RS, or SRS.

In some embodiments, to receive the at least one DCI scheduling the UE to receive the first set of PDSCHs and to transmit the PUCCH, the processor is further configured to, with the wireless transceiver, receive a single DCI, wherein the single DCI indicates at least two groups of DMRS ports and the at least two TCI states for the reception of the first set of PDSCHs.

In some embodiments, to receive the at least one DCI scheduling the UE to receive the first set of PDSCHs and to transmit the PUCCH, the processor is further configured to, with the wireless transceiver, receive at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the HARQ feedback(s) corresponding to the corresponding subset of the first set of PDSCHs.

In some embodiments, each of the at least one DCI indicates the same at least two candidate PUCCHs, wherein each candidate PUCCH of the at least two candidate PUCCHs is indicated to correspond to a separate UL Tx beam of the at least two UL Tx beams by higher layer signaling.

In some embodiments, the processor is further configured to: determine a PUCCH of the at least two candidate PUCCHs to be the PUCCH carrying the HARQ feedback(s) corresponding to the second set of PDSCHs, wherein the determined UL Tx beam corresponds to the determined PUCCH.

In some embodiments, to receive the at least one DCI scheduling the UE to receive the first set of PDSCHs and to transmit the PUCCH, the processor is further configured to, with the wireless transceiver, receive a single DCI, wherein the single DCI indicates at least two groups of DMRS ports and the at least two TCI states for the reception of the first set of PDSCHs.

In some embodiments, to receive the at least one DCI scheduling the UE to receive the first set of PDSCHs and to transmit the PUCCH, the processor is further configured to, with the wireless transceiver, receive at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the HARQ feedback(s) corresponding to the corresponding subset of the first set of PDSCHs.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary method according to some embodiments of the present disclosure;

FIG. 2 illustrates an exemplary scenario according to some embodiments of the present disclosure;

FIG. 3 illustrates an exemplary PDSCH reception and HARQ feedback transmission according to some embodiments of the present disclosure;

FIG. 4 (including (a) and (b)) illustrates two exemplary failure results generated by the directional LBT procedures;

FIG. 5 illustrates an exemplary PDSCH reception and HARQ feedback transmission according to some embodiments of the present disclosure;

FIG. 6 illustrates an exemplary PDSCH reception and HARQ feedback transmission according to some embodiments of the present disclosure;

FIG. 7 illustrates an exemplary PDSCH reception and HARQ feedback transmission according to some embodiments of the present disclosure;

FIG. 8 illustrates an exemplary PDSCH reception and HARQ feedback transmission according to some embodiments of the present disclosure; and

FIG. 9 illustrates an exemplary PDSCH reception and HARQ feedback transmission according to some embodiments of the present disclosure; and

FIG. 10 illustrates a simplified block diagram of an exemplary apparatus according to some embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP 5G NR, 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In some embodiments of the present disclosure, UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), road side units (RSUs), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, a BS may be referred to as an access point, an access terminal, a base, a base unit, a macro cell, a Node-B, an enhanced Node-B, an evolved Node B (eNB), a next generation Node B (gNB), a Home Node-B, a relay node, or a device, or described using other terminology used in the art. The BS is generally part of a radio access network that may include a controller communicably coupled to the BS.

For network of 3GPP 5G NR, when Multi-TRP transmission is not supported, a BS may schedule a UE to receive a set of PDSCHs, each of which carries one or more transport blocks (TBs), and to transmit a PUCCH carrying the HARQ feedbacks corresponding to the PDSCHs by a DCI. The one or more TBs may be mapped onto one or more layers of the PDSCH. A PDSCH layer refers to a set of time-frequency resources and a PDSCH consists of one or more PDSCH layers. The UE can receive and decode the PDSCHs according to the information indicated by the DCI, for example, the DMRS port corresponding to each PDSCH layer and the TCI state(s). According to a TCI state, the UE can identify a DL Tx beam used by the BS to perform the corresponding transmission. When the UE decodes the PDSCHs, it can generate the HARQ feedbacks corresponding to the PDSCHs and transmit the PUCCH carrying the HARQ feedbacks. A PUCCH also refers to a set of time-frequency resources and usually used to carry the UL control information including HARQ feedback. The BS will configure multiple candidate PUCCHs for the UE by higher layer signalling and schedule the UE to transmit one of them by the DCI. Corresponding to each candidate PUCCH, the BS will configure a UL Tx beam used by the UE to perform the transmission. More specifically, the BS will configure a spatial relation between the PUCCH and a RS, according to the spatial relation, the UE can identify the UL Tx beam.

For network of 3GPP 5G NR, a BS may use multiple TRPs for PDSCH transmission and PUCCH reception; accordingly, the BS may transmit PDSCHs from two geographically separated TRPs to a UE and receive PUCCHs from the UE via the two TRPs, wherein a TRP can act like a small BS and is used to serve one or more UEs under control of the BS. In different scenarios, the TRP may be referred to as different terms. Persons skilled in the art should understand that as the 3GPP and the communication technology develop, the terminologies recited in the specification may change, which should not affect the scope of the present disclosure. It should be understood that the TRPs configured for the BS may be transparent to a UE.

According to the present disclosure, Multi-TRP transmission can be performed on a single-DCI basis:
A BS may schedule a UE to receive a set of PDSCHs and to transmit a PUCCH carrying the HARQ feedback(s) corresponding to the PDSCHs by a single DCI, the single DCI indicates multiple groups of DMRS ports and multiple TCI states (i.e., multiple DL Tx beams) for the reception of the PDSCHs, wherein each group of DMRS ports and each TCI state correspond to a TRP; and
each PDSCH of the set of PDSCHs is a multi-layer PDSCH, and different PDSCH layers are transmitted from different TRPs using different DL Tx beams simultaneously, more specifically, the PDSCH layers corresponding to the same group of DMRS ports are transmitted from the same TRP using the corresponding DL Tx beam.

Multi-TRP transmission can also be performed on a Multi-DCI basis:
A BS may schedule a UE to receive a set of PDSCHs and to transmit a PUCCH carrying the HARQ feedback(s) corresponding to the PDSCHs by multiple DCIs, and each DCI schedules a subset of the set of PDSCHs and indicates a single TCI state (i.e., a single DL Tx beam) for the reception of the PDSCHs, wherein each TCI state corresponding to a TRP; and
different subset of the set of the PDSCHs scheduled by different DCIs are transmitted from different TRPs. Each DCI indicates the UE to transmit the same PUCCH carrying the HARQ feedback(s) corresponding to the subset of the set of the PDSCHs.

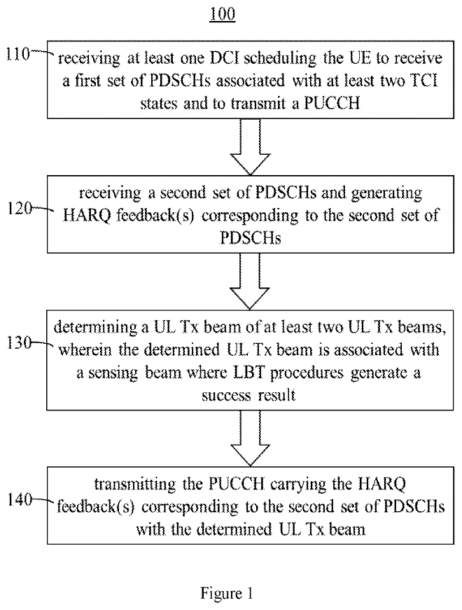

FIG. 1 illustrates an exemplary method 100 according to some embodiments of the present disclosure.

In operation 110, the UE receives at least one DCI from a BS scheduling the UE to receive a first set of PDSCHs associated with at least two TCI states and to transmit a PUCCH.

In some embodiments, in operation 110, the first set of PDSCHs is a set of multi-layer PDSCHs and the at least one DCI is a single DCI, which indicates the at least two TCI states; each TCI state corresponds to a TRP, so that the UE can identify the DL Tx beam used by the BS to transmit the corresponding PDSCH layers from the corresponding TRP according to each TCI state.

In some other embodiments, in operation 110, the first set of PDSCHs includes at least two subsets of the first set of PDSCHs; each subset of the first set of PDSCHs are transmitted from a TRP. The at least one DCI includes multiple DCIs, and each DCI indicates a TCI state of the at least two TCI states; each TCI state corresponds to a TRP, so that the UE can identify the DL Tx beam used by the BS to transmit the corresponding subset of the first set of the PDSCHs

In operation 120, the UE receives a second set of PDSCHs at a time point (in some embodiments, in a time slot) when the first set of PDSCHs are scheduled to be received, and generates HARQ feedback(s) corresponding to the second set of PDSCHs.

In some embodiments, the second set of PDSCHs is the same as the first set of PDSCHs. In some embodiments, the second set of PDSCHs is different from the first set of PDSCHs. For example, the first set of PDSCHs is scheduled to be transmitted within a COT initiated by the BS after performing LBT procedures with one or more DL sensing beams, if at least one TRP cannot be used due to the LBT procedures generate a failure result with at least one DL sensing beam, then the second set of PDSCHs is different from the first set of PDSCHs.

In operation 130, the UE determines a UL Tx beam of at least two UL Tx beams, wherein the determined UL Tx beam is associated with a sensing beam where LBT procedures generate a success result, that is, the sensing beam covers the determined UL Tx beam.

In operation 140, the UE transmits the PUCCH carrying the HARQ feedback(s) corresponding to the second set of PDSCHs with the determined UL Tx beam.

According to some embodiments of method 100, the PUCCH is transmitted within a time duration of a CO, wherein the CO is initiated by the BS or by the UE after performing LBT procedures.

In some embodiments of method 100, the PUCCH is transmitted within a time duration of a CO initiated by the BS after performing the LBT procedures. The LBT procedures are performed by the BS with at least two DL sensing beams, and a UL Tx beam may be determined as the UL Tx beam for transmitting the PUCCH carrying the HARQ feedback(s), wherein the determined UL Tx beam is associated with a DL sensing beam of the at least two DL sensing beams, that is, the determined UL Tx beam is covered by the DL sensing beam where the LBT procedures generate a success result. There are multiple methods regarding how the UE determines that a UL Tx beam is covered by the DL sensing beam where the LBT procedures generate a success result, for example,
the gNB may configure relation between a DL Tx beam or a DL sensing beam and a UL Tx beam by higher layer signalling, more specifically, configure relation between a SSB/CSI-RS and a SSB/CSI-RS/SRS. According to the higher layer signalling, the UE can determine that the UL Tx beam is covered by the DL Tx beam or the DL sensing beam.
the gNB may transmit a DCI indicating the DL sensing beam(s) where LBT procedures generate a success result.
the gNB may configure a DCI or a PDSCH corresponding to a TRP and configure a UL Tx beam corresponding to a TRP.
the UE can determine that the UL Tx beam is covered by a DL sensing beam where the LBT procedures generate a success result according to that the UE receives the DCI or the PDSCH, wherein the UL Tx beam and the DCI or the PDSCH are corresponding to the same TRP.

Persons skilled in the art should understand that the various methods should not affect the scope of the present disclosure.

In some embodiments of method 100, the PUCCH is transmitted within a time duration of a CO initiated by the UE after performing the LBT procedures. The LBT procedures are performed by the UE with at least two UL sensing beams, and a UL Tx beam may be determined as the UL Tx beam for transmitting the PUCCH carrying the HARQ feedback(s), wherein the determined UL Tx beam is associated with a UL sensing beam of the at least two UL sensing beams, that is, the determined UL Tx beam is covered by the UL sensing beam where the LBT procedures generate a success result.

In some embodiments according to the present disclosure, the at least two UL Tx beams in operation 130 are configured to be corresponding to the PUCCH by higher layer signalling, wherein each UL Tx beam corresponds to a TRP. According to the present disclosure, there are multiple methods regarding how to indicate the at least two UL Tx beams corresponding to the PUCCH by the higher layer signalling. For example, the higher layer signalling can indicate the spatial relation between more than one RSs and a PUCCH, wherein an RS can be an SSB, CSI-RS, or SRS. The UE can identify the at least two UL Tx beams which can be used to transmit the PUCCH according to the more than one RSs.

In some embodiments according to the present disclosure, each of the at least one DCI can indicate at least two candidate PUCCHs, wherein each candidate PUCCH is indicated to correspond to a UL Tx beam of the at least two UL Tx beams in operation 130 by higher layer signaling and each UL Tx beam corresponds to a TRP. According to the present disclosure, there are multiple methods regarding how to indicate the at least two candidate PUCCHs by an indicator in a DCI. For example, the at least two candidate PUCCHs can be configured as a PUCCH group by higher layer signaling and the DCI indicates the first PUCCH; when receiving the DCI, the UE can determine all the at least two candidate PUCCHs in the same PUCCH group. In operation 130, the UE determines one of the at least two candidate PUCCHs to be the PUCCH carrying the HARQ feedback(s) corresponding to the second set of PDSCHs, wherein the determined PUCCH corresponding to the determined UL Tx beam.

Hereinafter various methods and embodiments based on method 100 are provided for HARQ feedback(s) transmission via a PUCCH upon reception of a set of PDSCHs associated with at least two TCI states.

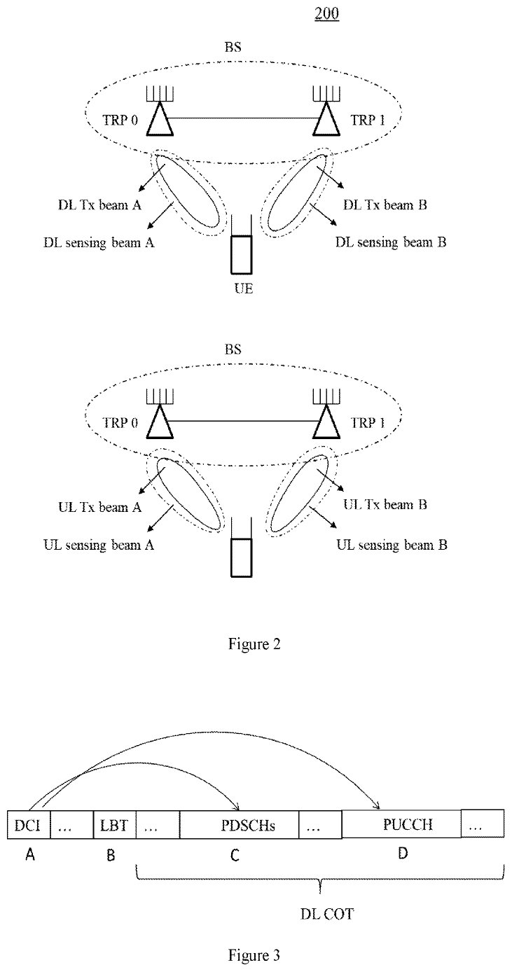

FIG. 2 illustrates exemplary scenario 200 according to the present disclosure. As shown in FIG. 2, a BS communicates with a UE via at least one of two TPRs: TRP 0 and TRP 1; DL Tx beam A can be used by the BS for PDSCH transmission from TRP 0, DL sensing beam A can be used by the BS to perform LBT procedures and covers DL Tx beam A and UL Tx beam A; UL Tx beam A can be used by the UE for PUCCH transmission to TRP 0, UL sensing beam A can be used by the UE to perform LBT procedures and covers UL Tx beam A; DL Tx beam B can be used by the BS for PDSCH transmission from TRP 1, DL sensing beam B can be used by the BS to perform LBT procedures and covers DL Tx beam B and UL Tx beam B; UL Tx beam B can be used by the UE for PUCCH transmission to TRP 1, UL sensing beam B can be used by the UE to perform LBT procedures and covers UL Tx beam B. That is, DL Tx beam A and UL Tx beam A correspond to TRP 0 while DL Tx beam B and UL Tx beam B correspond to TRP 1.

The following described examples are based on scenario 200 for simplicity and conciseness. However, it is appreciated that the spirit of the present disclosure is not limited to scenario 200.

An embodiment according to the present disclosure is illustrated in FIG. 3.

In this example, the exemplary PDSCH reception and PUCCH transmission are on a single-DCI basis, UL Tx beam A and UL Tx beam B are configured to be corresponding to the PUCCH by higher layer signaling, that is, UL Tx beam A and UL Tx beam B can be used by the UE for PUCCH transmission.

On time point A, a UE receives a single DCI scheduling the UE to receive a 4-layer PDSCH on time point C from TRP 0 and TRP 1 and scheduling the UE to transmit a PUCCH carrying HARQ feedback corresponding to the 4-layer PDSCH on time point D. In this example, the first set of PDSCHs only includes this 4-layer PDSCH. The DCI indicates two groups of DMRS ports for the PDSCH reception, more specifically, group 0 of DMRS ports corresponds to TRP 0 and consists of DMRS port 0 and DMRS port 1, group 1 of DMRS ports corresponds to TRP 1 and consists of DMRS port 2 and DMRS port 3. The DCI also indicates TCI state 0 corresponding to TRP 0 and TCI state 1 corresponding to TRP 1, that is, the UE can determine DL Tx beam A can be used for PDSCH transmission from TRP 0 and DL Tx beam B can be used for PDSCH transmission from TRP 1.

According to the present disclosure, in some embodiments, on a time point means within a time slot. For example, in some embodiments, being on time point A equates being within time slot A.

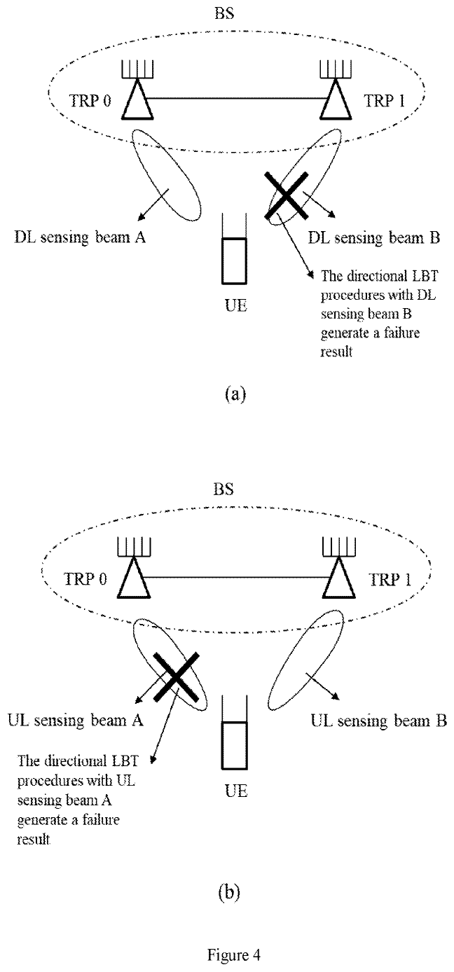

As time point C and time point D are not within any existing COT initiated by the BS or the UE, on time point B, the BS starts performing directional LBT procedures with DL sensing beam A and DL sensing beam B and initiates a CO, time point C and time point D are within the time duration of the CO, i.e., time point C and time point D are within the DL COT illustrated in FIG. 3. In this example, the directional LBT procedures generate a success result with DL sensing beam A while generate a failure result with DL sensing beam B, as shown in FIG. 4(a); therefore, DL Tx beam B cannot be used for PDSCH transmission, and the PDSCH layers corresponding to DMRS port 2 and DMRS port 3 cannot be transmitted with DL Tx beam B.

Therefore, on time point C, the BS transmits a 2-layer PDSCH corresponding to DMRS port 0 and DMRS port 1, rather than the 4-layer PDSCH, to the UE with DL Tx beam A; the UE receives the 2-layer PDSCH on time point C and generates HARQ feedback corresponding to the 2-layer PDSCH.

On time point D, based on that UL Tx beam A is covered by the DL sensing beam A where LBT procedures generate a success result, the UE determines that UL Tx beam A can be used for PUCCH transmission, and the UE transmits the PUCCH carrying the HARQ feedback corresponding to the 2-layer PDSCH with UL Tx beam A.

In some cases, the LBT procedures performed by the BS on time point B may generate success results with both DL sensing beam A and DL sensing beam B. Then on time point C, the UE receives the 4-layer PDSCHs via TRP 0 and TRP 1. On time point D, the UE may select one of UL Tx beam A and UL Tx beam B for PUCCH transmission, and may transmit a PUCCH carrying the HARQ feedbacks according to the set of 4-layer PDSCHs with the selected UL Tx beam. There are multiple methods regarding how to select one of the indicated UL Tx beams, for example, the UE select the UL Tx beam which has been used most recently.

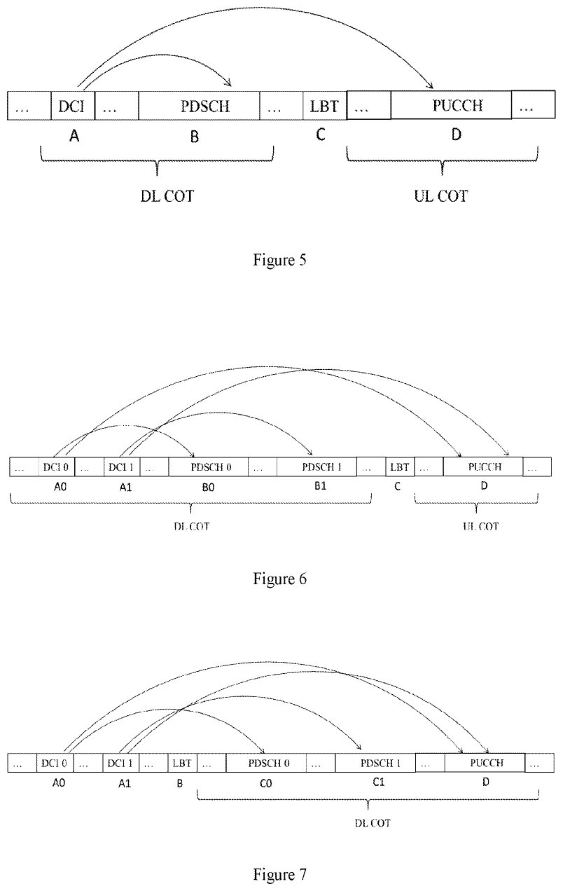

Another embodiment according to the present disclosure is illustrated in FIG. 5.

In this example, the exemplary PDSCH reception and PUCCH transmission are on a single-DCI basis, UL Tx beam A and UL Tx beam B are configured to the PUCCH by higher layer signaling, that is, UL Tx beam A and UL Tx beam B can be used by the UE for PUCCH transmission.

On time point A, a UE receives a single DCI scheduling the UE to receive a 4-layer PDSCH on time point B from TRP 0 and TRP 1 and scheduling the UE to transmit a PUCCH carrying HARQ feedback corresponding to the 4-layer PDSCH on time point D. In this example, the first set of PDSCHs only includes the 4-layer PDSCH. The DCI indicates two groups of DMRS ports for the PDSCH reception, more specifically, group 0 of DMRS ports corresponds to TRP 0 and consists of DMRS port 0 and DMRS port 1, group 1 of DMRS ports corresponds to TRP 1 and consists of DMRS port 2 and DMRS port 3. The DCI also indicates TCI state 0 corresponding to TRP 0 and TCI state 1 corresponding to TRP 1, that is, the UE can determine DL Tx beam A can be used for PDSCH transmission from TRP 0 and DL Tx beam B can be used for PDSCH transmission from TRP 1.

According to the present disclosure, in some embodiments, on a time point means within a time slot. For example, in some embodiments, being on time point A equates being within time slot A.

In this example, time point B is within an existing DL COT initiated by the BS. Within the DL COT, all the DL Tx beams are available; therefore, the BS transmits the 4-layer PDSCH to the UE, the UE generates a HARQ feedback after reception of the 4-layer PDSCH.

In this example, time point D is not within any existing COT initiated by the BS or the UE; therefore, on time point C, the UE starts performing directional LBT procedures with UL sensing beam A and UL sensing beam B and initiates a CO, time point D is within the time duration of the CO, i.e., time point D is within the UL COT illustrated in FIG. 5. In this example, the directional LBT procedures performed by the UE generate a failure result with UL sensing beam A while generate a success result with UL sensing beam B, as shown in FIG. 4(b); accordingly, UL Tx beam A cannot be used for PUCCH transmission, and the UE determines that UL Tx beam B can be used for PUCCH transmission based on that UL Tx beam B is covered by the UL sensing beam B where LBT procedures generate a success result. On time point D, the UE transmits a PUCCH carrying the HARQ feedback with UL Tx beam B.

This example is not limited to the above case. In some other cases, within the DL COT, only one of DL Tx beam A and DL Tx beam B is available or usable, the BS transmits a 2-layer PDSCH instead of the 4-layer PDSCH to the UE on time point B.

Furthermore, in some other cases, the LBT procedures performed by the UE on time point C may generate success results with both UL sensing beam A and UL sensing beam B. Then on time point D, the UE may select one of UL Tx beam A and UL Tx beam B for PUCCH transmission, and may transmit a PUCCH carrying the HARQ feedbacks according to the received PDSCH with the selected UL Tx beam. There are multiple methods regarding how to select one of the indicated UL Tx beams, for example, the UE select the UL Tx beam which has been used most recently.

One more embodiment according to the present disclosure is illustrated in FIG. 6.

In this example, the exemplary PDSCH reception and PUCCH transmission are on a multi-DCI basis, and two UL Tx beams are configured to be corresponding to the PUCCH by higher layer signaling, that is, UL Tx beam A and UL Tx beam B can be used by the UE for PUCCH transmission.

On time point A0, a UE receives DCI 0 scheduling the UE to receive PDSCH 0 on time point B0 from TRP 0 of a BS and to transmit a PUCCH on time point D. Furthermore, DCI 0 indicates TCI state 0 corresponding to TRP 0, that is, the UE can determine DL Tx beam A can be used for PDSCH transmission from TRP 0.

On time point A1, the UE receives DCI 1 scheduling the UE to receive PDSCH 1 on time point B1 from TRP 1 of the BS and to transmit the same PUCCH on time point D. Furthermore, DCI 1 indicates that TCI state 1 corresponding to TRP 1, that is, the UE can determine DL Tx beam B can be used for PDSCH transmission from TRP 1.

In this example, the DCI 0 and DCI 1 indicate that the UE transmits the PUCCH carries the HARQ feedbacks corresponding to PDSCH 0 and PDSCH 1 on time point D.

In this example, time point B0 and B1 are within a time duration of a DL CO (i.e., within the DL COT illustrated in FIG. 6); the BS does not need to perform any more LBT procedures.

If both DL Tx beam A and DL Tx beam B are available during the DL COT, i.e., the LBT procedures performed by the BS to initiate the CO generate success results with both DL sensing beam A and DL sensing beam B, the BS transmits PDSCH 0 on time point B0 via TRP 0, and transmits PDSCH 1 on time point B1 via TRP 1, and the UE receives and decodes PDSCH 0 and PDSCH 1 respectively on time point B0 and time point B1.

If only DL Tx beam A is available during the DL COT, i.e., the LBT procedures performed by the BS to initiate the CO generate success results with DL sensing beam A while generate failure results with DL sensing beam B, the BS transmits PDSCH 0 on time point B0 via TRP 0, and will not transmit PDSCH 1 on time point B1 via TRP 1, the UE receives only PDSCH 0; if only DL Tx beam B is available, i.e., the LBT procedures performed by the BS to initiate the CO generate success results with DL sensing beam B while generate failure results with DL sensing beam A, the BS transmits PDSCH 1 on time point B1 via TRP 1, and will not transmit PDSCH 0 on time point B0 via TRP 0, the UE receives only PDSCH 1.

The UE generates HARQ feedback(s) corresponding to the received PDSCH(s).

In this example, the PUCCH for carrying the HARQ feedback(s) is scheduled to be transmitted on time point D which is out of any existing COT; then the UE performs LBT procedures with both UL sensing beam A and UL sensing beam B on time point C before time point D and initiates a CO; time point D is within the time duration of the corresponding UL COT, as shown in FIG. 6.

If the LBT procedures performed by the UE generate successful results with both UL sensing A and UL sensing B, the UE may select one of the two UL Tx beams, and transmits the PUCCH carrying HARQ feedback(s) on time point D. There are multiple methods regarding how to select one of the indicated UL Tx beams, for example, the UE select the UL Tx beam which has been used most recently.

If the LBT procedures performed by the UE generate success results with UL sensing beam B while generate failure results with UL sensing beam A, the UE determines the UL Tx beam B can be used to transmit the PUCCH based on that the UL Tx beam B is covered by the UL sensing beam B where the LBT procedures generate success results, and transmits the PUCCH carrying HARQ feedback(s) with the UL Tx beam B on time point D.

One more embodiment according to the present disclosure is illustrated in FIG. 7.

In this example, the exemplary PDSCH reception and PUCCH transmission are on a multi-DCI basis, UL Tx beam A and UL Tx beam B are configured to be corresponding to the PUCCH by higher layer signaling, that is, UL Tx beam A and UL Tx beam B can be used by the UE for PUCCH transmission.

On time point A0, a UE receives DCI 0 scheduling the UE to receive PDSCH 0 on time point C0 from TRP 0 of a BS and to transmit a PUCCH on time point D. Furthermore, DCI 0 indicates that TCI state 0 corresponding to TRP 0, that is, the UE can determine DL Tx beam A can be used for PDSCH transmission from TRP 0.

On time point A1, the UE receives DCI 1 scheduling the UE to receive PDSCH 1 on time point C1 from TRP 1 of the BS and to transmit the same PUCCH on time point D. Furthermore, DCI 1 indicates that TCI state 1 corresponding to TRP 1, that is, the UE can determine DL Tx beam B can be used for PDSCH transmission from TRP 1.

In this example, the DCI 0 and DCI 1 indicate that the UE transmits the PUCCH carries the HARQ feedbacks corresponding to PDSCH 0 and PDSCH 1 on time point D.

In this example, time point C0, time point C1, and time point D are not within any existing time duration of a CO initiated by the BS or the UE. Therefore, the BS performs LBT procedures with DL sensing beam A and DL sensing beam B on time point B and initiates a CO; time point C0, time point C1, and time point D are within the time duration of the initiated CO, i.e., the DL COT illustrated in FIG. 7.

If both DL Tx beam A and DL Tx beam B are available during the DL COT, i.e., the LBT procedures performed by the BS to initiate the CO generate success results with both DL sensing beam A and DL sensing beam B, the BS transmits PDSCH 0 on time point B0 via TRP 0, and transmits PDSCH 1 on time point B1 via TRP 1, and the UE receives and decodes PDSCH 0 and PDSCH 1 respectively on time point B0 and time point B1. The UE generates HARQ feedbacks corresponding to PDSCH 0 and PDSCH 1, and selects one of the two UL Tx beams, and transmits the PUCCH carrying HARQ feedback on time point D with the selected UL Tx beam. There are multiple methods regarding how to select one of the indicated UL Tx beams, for example, the UE select the UL Tx beam which has been used most recently.

If the LBT procedures performed by the BS generate success results on DL sensing beam A while generate failure results on DL sensing beam B (as shown in FIG. 4(a)), then only DL Tx beam A is available during the DL COT, the BS transmits PDSCH 0 on time point B0 via TRP 0, and will not transmit PDSCH 1 on time point B1 via TRP 1, the UE receive only PDSCH 0. The UE generates a HARQ feedback corresponding to PDSCH 0. Since UL Tx beam A is covered by the DL sensing beam A where the LBT procedures generate a success result, the UE determines that UL Tx beam A can be used for PUCCH transmission, and transmits the PUCCH carrying the HARQ feedback on time point D with the UL Tx beam A.

If the LBT procedures performed by the BS generate failure results on DL sensing beam A while generate success results on DL sensing beam B, then only DL Tx beam B is available, the BS transmits PDSCH 1 on time point B1 via TRP 1, and will not transmit PDSCH 0 on time point B0 via TRP 0. The UE receive only PDSCH 1 and generates a HARQ feedback corresponding to PDSCH 1. Since UL Tx beam B is covered by the DL sensing beam B where the LBT procedures generate a success result, the UE determines that UL Tx beam B can be used for PUCCH transmission, and transmits the PUCCH carrying the HARQ feedback on time point D with the UL Tx beam B.

One more embodiment according to the present disclosure is illustrated in FIG. 8.

In this exemplary embodiment, the PDSCH reception and PUCCH transmission are on a single-DCI basis, and the DCI indicate two candidate PUCCHs: PUCCH 0 and PUCCH 1, wherein PUCCH 0 corresponds to UL Tx beam A and TRP 0, and PUCCH 1 corresponds to UL Tx beam B and TRP 1.

On time point A, a UE receives a single DCI scheduling the UE to receive a 4-layer PDSCH on time point B from TRP 0 and TRP 1; furthermore, the DCI indicates two candidate PUCCHs: PUCCH 0 and PUCCH 1, wherein PUCCH 0 is scheduled to be transmitted on time point C0 with UL Tx beam A via TRP 0 of a BS, and PUCCH 1 is scheduled to be transmitted on time point C1 with UL Tx beam B via TRP 1 of the BS, the UE will determine one of the two candidate PUCCHs as a PUCCH carrying HARQ feedbacks to be transmitted to the BS. The DCI indicates two groups of DMRS ports for the PDSCH transmission, more specifically, group 0 of DMRS ports corresponds to TRP 0 and consists of DMRS port 0 and DMRS port 1, group 1 of DMRS ports corresponds to TRP 1 and consists of DMRS port 2 and DMRS port 3. The DCI also indicates TCI state 0 corresponding to TRP 0 and TCI state 1 corresponding to TRP 1, that is, the UE can determine DL Tx beam A can be used for PDSCH transmission from TRP 0 and DL Tx beam B can be used for PDSCH transmission from TRP 1.

In this example, if time point B is out of any existing COT of the BS or the UE, the BS needs to perform LBT procedures with DL sensing beam A and DL sensing beam B and initiate a DL CO before time point B, wherein the results generated by the LBT procedures are used to determine which of DL Tx beam A and DL Tx beam B is available for PDSCH transmission; time point B is within the time duration of the DL CO.

In this example, if time point B is within an existing COT of the BS or the UE, the BS does not need to perform additional LBT procedures and knows which DL Tx beam(s) are available for PDSCH transmission.

Anyway, time point B should be within a COT, e.g., COT 0 illustrated in FIG. 8.

In this example, if only one of DL Tx beam A and DL Tx beam B is available within COT 0, the BS transmits a 2-layer PDSCH instead of the 4-layer PDSCH on time point B; if both of the two DL Tx beams are available, the BS transmits the 4-layer PDSCH on time point B.

After the UE receives the 2-layer PDSCH or the 4-layer PDSCH at time point B, the UE generates HARQ feedbacks corresponding to the received PDSCH.

In this example, PUCCH 0 and PUCCH 1 are scheduled to be transmitted on time point C0 and time point C1 respectively. If time point C0 and time point C1 are out of any existing COT of the BS and the UE, the UE needs to perform LBT procedures before time point C0 and initiate a CO; based on the results generated by the LBT procedures, the UE determines which of UL Tx beam A and UL Tx beam B is available for transmitting the corresponding PUCCH carrying HARQ feedbacks to the BS; time point C0 and time point C1 are within the time duration of the CO. If time point C0 and time point C1 are within an existing COT of the BS or the UE, the UE knows which of UL Tx beam A and UL Tx beam B is available and does not need to perform additional LBT procedures. Anyway, time point C0 and time point C1 should be within a COT (e.g., COT 1 illustrated in FIG. 8).

If both UL Tx beam A and UL Tx beam B are available within COT 1, the UE may select one of PUCCH 0 and PUCCH 1 carrying HARQ feedbacks to be transmitted to the BS.

If only one of UL Tx beam A and UL Tx beam B is available within COT 1, for example, only UL Tx beam A is available within COT 1, the UE transmits PUCCH 0 carrying the HARQ feedbacks on time point C0; if only UL Tx beam B is available within COT 1, the UE transmits PUCCH 1 carrying the HARQ feedbacks on time point C1.

The present disclosure is not limited to the example illustrated in FIG. 8. For example, time point C0 and time point C1 may be within different COTs. Furthermore, only one of time point C0 and time point C1 that associated with the selected PUCCH for carrying HARQ feedback(s) is needed to be within a COT. Moreover, time point B, time point C0, and time point C1 may be within a same COT.

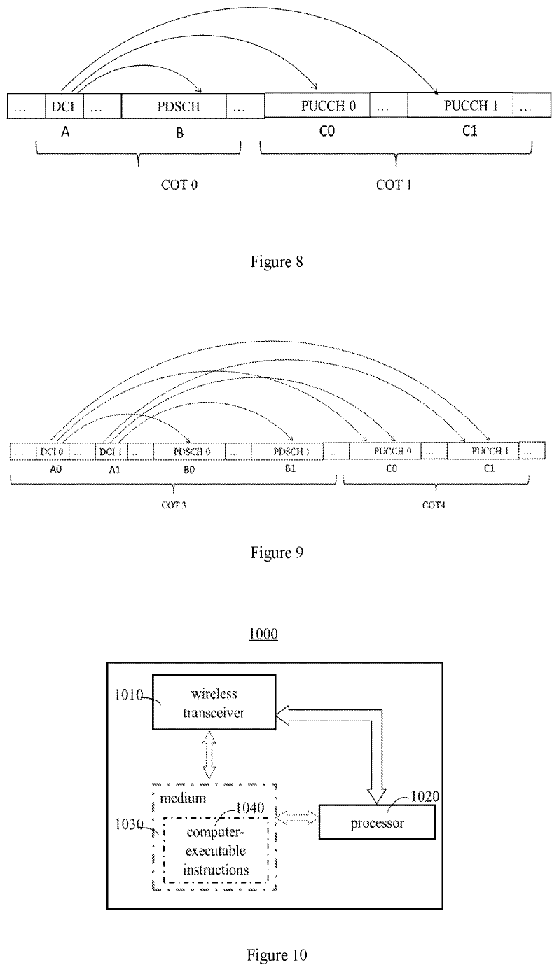

One more embodiment according to the present disclosure is illustrated in FIG. 9.

In this example, the exemplary PDSCH reception and PUCCH transmission are on a multi-DCI basis, each DCI indicates the same two candidate PUCCHs: PUCCH 0 and PUCCH 1, wherein PUCCH 0 corresponds to UL Tx beam A and TRP 0, and PUCCH 1 corresponds to UL Tx beam B and TRP 1. In this example, each DCI schedules the UE to receive PDSCH(s) from a TRP.

On time point A0, a UE receives DCI 0 scheduling the UE to receive PDSCH 0 on time point B0 from TRP 0 of a BS. Furthermore, DCI 0 indicates PUCCH 0 and PUCCH 1 corresponding to PDSCH 0, and indicates the UE to transmit PUCCH 0 and PUCCH 1 on time point C0 and time point C1 respectively, wherein PUCCH 0 corresponds to UL Tx beam A, PUCCH 1 corresponds to UL Tx beam B. Moreover, DCI 0 indicates that TCI state 0 corresponding to TRP 0.

On time point A1, the UE receives DCI 1 scheduling the UE to receive PDSCH 1 on time point B1 from TRP 1 of the BS. Furthermore, DCI 1 indicates PUCCH 0 and PUCCH 1 corresponding to PDSCH 1, and indicates the UE to transmit PUCCH 0 and PUCCH 1 on time point C0 and time point C1 respectively, wherein PUCCH 0 corresponds to UL Tx beam A, PUCCH 1 corresponds to UL Tx beam B. Moreover, DCI 1 indicates that TCI state 1 corresponding to TRP 1.

In this example, time point A0, A1, B0, and B1 are within a time duration of a CO initiated by the BS or the UE after performing LBT procedures before time point A0; if both DL Tx beam A and DL Tx beam B are available within COT 3, the BS transmits PDSCH 0 on time point B0 via TRP 0, and transmits PDSCH 1 on time point B1 via TRP 1, and the UE receives and decodes PDSCH 0 and PDSCH 1 respectively on time point B0 and time point B1; if only DL Tx beam A is available within COT 3, the BS transmits PDSCH 0 on time point B0 via TRP 0, and will not transmit PDSCH 1 on time point B1 via TRP 1, the UE receives only PDSCH 0; if only DL Tx beam B is available within COT 3, the BS transmits PDSCH 1 on time point B1 via TRP 1, and will not transmit PDSCH 0 on time point B0 via TRP 0, the UE receives only PDSCH 1.

After the UE receives at least one of PDSCH 0 and PDSCH 1, the UE generates HARQ feedback(s).

In this example, time point C0 and time point C1 are within a time duration of a CO (e.g., COT 4 illustrated in FIG. 9) initiated by the BS or the UE after performing LBT procedures before time point C0.

During COT 4, if both UL Tx beam A and UL Tx beam B are available, the UE may select one of PUCCH 0 and PUCCH 1 carrying the HARQ feedbacks to be transmitted to the BS. For example, if PUCCH 1 is selected to be transmitted to the BS, the HARQ feedback(s) corresponding to received PDSCH(s) will be carried by the PUCCH 1, which is transmitted with UL Tx beam B on time point C1.

During COT 4, if only one UL Tx beam of UL Tx beam A and UL Tx beam B is available, for example, only UL Tx beam A is available, then PUCCH 0 is selected to be transmitted carrying the HARQ feedback(s) to the BS, the HARQ feedback(s) corresponding to received PDSCH(s) will be carried by the PUCCH 0, which is transmitted with UL Tx beam A on time point C0.

The present disclosure is not limited to the example illustrated in FIG. 9. For example, time point C0 and time point C1 may be within different COTs. Furthermore, time point B0, time point B1, time point C0, and time point C1 may be within a same COT. For example, time point C0 and time point C1 may be the same time point.

According to the present disclosure, the BS may perform a method corresponding to method 100 performed by the UE.

Based on the above description, the present disclosure provides various methods and exemplary embodiments for PUCCH transmission in case of multiple TRPs scenario.

Based on the above description, the present disclosure provides various methods and exemplary embodiments for a UE to determine one of more than one UL Tx beams configured for HARQ feedback(s) transmission via a PUCCH according to the directional LBT results.

Based on the above description, the present disclosure provides various methods and exemplary embodiments for a UE to determine one of the more than one PUCCHs indicated in each DCI for carrying HARQ feedback(s) according to the directional LBT results.

FIG. 10 illustrates a simplified block diagram of an exemplary apparatus 1000 according to various embodiments of the present disclosure. Apparatus 1000 may be or include at least a part of a UE or similar device having similar functionality.

As shown in Figure 1010, apparatus 1000 may include at least wireless transceiver 1010 and processor 1020, wherein wireless transceiver 1010 may be coupled to processor 1020. Furthermore, apparatus 1000 may include non-transitory computer-readable medium 1030 with computer-executable instructions 1040 stored thereon, wherein non-transitory computer-readable medium 1030 may be coupled to processor 1020, and computer-executable instructions 1040 may be configured to be executable by processor 1020. In some embodiments, wireless transceiver 1010, non-transitory computer-readable medium 1030, and processor 1020 may be coupled to each other via one or more local buses.

Although in FIG. 10, elements such as wireless transceiver 1010, non-transitory computer-readable medium 1030, and processor 1020 are described in the singular, the plural is contemplated unless limitation to the singular is explicitly stated. In some embodiments of the present disclosure, the wireless transceiver 1010 may be configured for wireless communication. In some embodiments of the present disclosure, wireless transceiver 1010 can be integrated into a transceiver. In certain embodiments of the present disclosure, the apparatus 1000 may further include other components for actual usage.

Processor 1020 is configured to cause the apparatus 1000 at least to perform, with wireless transceiver 1010, method 100 and embodiments described above which are performed by a UE according to the present disclosure.

According to the present disclosure, processor 1020 is configured to receive, with wireless transceiver 1010, at least one DCI from a BS scheduling the UE to receive a first set of PDSCHs associated with at least two TCI states and to transmit a PUCCH; receive, with wireless transceiver 1010, a second set of PDSCHs and generating HARQ feedback(s) corresponding to the second set of PDSCHs; determine a UL Tx beam of at least two UL Tx beams, wherein the determined UL Tx beam is associated with a sensing beam where LBT procedures generate a success result; and transmit, with wireless transceiver 1010, the PUCCH carrying the HARQ feedback(s) corresponding to the second set of PDSCHs with the determined UL Tx beam.

In some embodiments, the LBT procedures are performed by the base station (BS) with at least two DL sensing beams including the sensing beam where LBT procedures generate a success result, and the PUCCH is transmitted within a time duration of a CO initiated by the BS.

In some embodiments, the LBT procedures are performed by the UE with at least two UL sensing beams including the sensing beam where LBT procedures generate a success result, and the PUCCH is transmitted within a time duration of a CO initiated by the UE.

In some embodiments, the at least two UL Tx beams are indicated to be associated with the PUCCH by higher layer signaling.

In some embodiments, the high layer signaling indicates spatial relation between at least two RSs and the PUCCH, wherein each of the at least two RSs is an SSB, CSI-RS, or SRS.

In some embodiments, to receive the at least one DCI scheduling the UE to receive the first set of PDSCHs and to transmit the PUCCH, processor 1020 is further configured to, with wireless transceiver 1010, receive a single DCI, wherein the single DCI indicates at least two groups of DMRS ports and the at least two TCI states for the reception of the first set of PDSCHs.

In some embodiments, to receive the at least one DCI scheduling the UE to receive the first set of PDSCHs and to transmit the PUCCH, processor 1020 is further configured to, with wireless transceiver 1010, receive at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the HARQ feedback(s) corresponding to the corresponding subset of the first set of PDSCHs.

In some embodiments, each of the at least one DCI indicates the same at least two candidate PUCCHs, wherein each candidate PUCCH of the at least two candidate PUCCHs is indicated to correspond to a separate UL Tx beam of the at least two UL Tx beams by higher layer signaling.

In some embodiments, processor 1020 is further configured to: determine a PUCCH of the at least two candidate PUCCHs to be the PUCCH carrying the HARQ feedback(s) corresponding to the second set of PDSCHs, wherein the determined UL Tx beam corresponds to the determined PUCCH.

In some embodiments, to receive the at least one DCI scheduling the UE to receive the first set of PDSCHs and to transmit the PUCCH, processor 1020 is further configured to, with wireless transceiver 1010, receive a single DCI, wherein the single DCI indicates at least two groups of DMRS ports and the at least two TCI states for the reception of the first set of PDSCHs.

In some embodiments, to receive the at least one DCI scheduling the UE to receive the first set of PDSCHs and to transmit the PUCCH, processor 1020 is further configured to, with wireless transceiver 1010, receive at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the HARQ feedback(s) corresponding to the corresponding subset of the first set of PDSCHs.

In various example embodiments, processor 1020 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 1020 may also include at least one other circuitry or element not shown in FIG. 10.

In various example embodiments, non-transitory computer-readable medium 1030 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 1030 may include, but is not limited to, an electric, a magnetic, an optical, an electromagnetic, an infrared, or a semiconductor system, apparatus, or device or any combination of the above.

Further, in various example embodiments, exemplary apparatus 1000 may also include at least one other circuitry, element, and interface, for example antenna element, and the like.

In various example embodiments, the circuitries, parts, elements, and interfaces in exemplary apparatus 1000, including processor 1020 and non-transitory computer-readable medium 1030, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A method performed by a user equipment (UE), comprising:
receiving at least one downlink control information (DCI) from a base station (BS) scheduling the UE to receive a first set of physical downlink shared channels (PDSCHs) associated with at least two transmission configuration indication (TCI) states and to transmit a physical uplink control channel (PUCCH);
receiving a second set of PDSCHs and generating one or more hybrid automatic repeat request (HARQ) feedbacks corresponding to the second set of PDSCHs;
determining an uplink (UL) transmission (Tx) beam of at least two UL Tx beams, wherein the determined UL Tx beam is associated with a sensing beam where listen-before-transmit (LBT) procedures generate a success result; and
transmitting the PUCCH carrying the one or more HARQ feedbacks corresponding to the second set of PDSCHs with the determined UL Tx beam.

2. The method of claim 1, wherein the at least two UL Tx beams are indicated to be associated with the PUCCH by higher layer signaling.

3. The method of claim 1, wherein each of the at least one DCI indicates at least two candidate PUCCHs, wherein each candidate PUCCH of the at least two candidate PUCCHs is indicated to correspond to a separate UL Tx beam of the at least two UL Tx beams by higher layer signaling.

4. The method of claim 3, further comprising:
determining a PUCCH of the at least two candidate PUCCHs to be the PUCCH carrying the one or more HARQ feedbacks corresponding to the second set of PDSCHs, wherein the determined UL Tx beam corresponds to the determined PUCCH.

5. A user equipment (UE) for wireless communication, comprising:
at least one memory; and
at least one processor coupled with the at least one memory and configured to cause the UE to:
receive, from a base station (BS), at least one downlink control information (DCI) scheduling the UE to receive a first set of physical downlink shared channels (PDSCHs) associated with at least two transmission configuration indication (TCI) states and to transmit a physical uplink control channel (PUCCH);
receive, from the BS, a second set of PDSCHs and generating one or more hybrid automatic repeat request (HARQ) feedbacks corresponding to the second set of PDSCHs;
determine an uplink (UL) transmission (Tx) beam of at least two UL Tx beams, wherein the determined UL Tx beam is associated with a sensing beam where listen-before-transmit (LBT) procedures generate a success result; and
transmit, to the BS, the PUCCH carrying the one or more HARQ feedbacks corresponding to the second set of PDSCHs with the determined UL Tx beam.

6. The UE of claim 5, wherein the LBT procedures are performed by the BS with at least two downlink (DL) sensing beams including the sensing beam where the LBT procedures generate the success result, and the PUCCH is transmitted within a time duration of a channel occupancy (CO) initiated by the BS.

7. The UE of claim 5, wherein the LBT procedures are performed by the UE with at least two UL sensing beams including the sensing beam where the LBT procedures generate the success result, and the PUCCH is transmitted within a time duration of a channel occupancy (CO) initiated by the UE.

8. The UE of claim 5, wherein the at least two UL Tx beams are indicated to be associated with the PUCCH by higher layer signaling.

9. The UE of claim 8, wherein the higher layer signaling indicates a spatial relation between at least two reference signals (RSs) and the PUCCH, wherein each of the at least two RSs is a synchronization signal block (SSB), a channel state information RS (CSI-RS), or a sounding reference signal (SRS).

10. The UE of claim 5, wherein to receive the at least one DCI scheduling the UE to receive the first set of PDSCHs and to transmit the PUCCH, the at least one processor is configured to cause the UE to receive a single DCI, wherein the single DCI indicates at least two groups of demodulation reference signal (DMRS) ports and the at least two TCI states for the reception of the first set of PDSCHs.

11. The UE of claim 5, wherein to receive the at least one DCI scheduling the UE to receive the first set of PDSCHs and to transmit the PUCCH, the at least one processor is configured to cause the UE to receive at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the one or more HARQ feedbacks corresponding to the corresponding subset of the first set of PDSCHs.

12. The UE of claim 5, wherein each of the at least one DCI indicates at least two candidate PUCCHs, wherein each candidate PUCCH of the at least two candidate PUCCHs is indicated to correspond to a separate UL Tx beam of the at least two UL Tx beams by higher layer signaling.

13. The UE of claim 12, wherein the at least one processor is configured to cause the UE to determine a PUCCH of the at least two candidate PUCCHs to be the PUCCH carrying the one or more HARQ feedbacks corresponding to the second set of PDSCHs, wherein the determined UL Tx beam corresponds to the determined PUCCH.

14. The UE of claim 13, wherein to receive the at least one DCI scheduling the UE to receive the first set of PDSCHs and to transmit the PUCCH, the at least one processor is configured to cause the UE to receive a single DCI, wherein the single DCI indicates at least two groups of demodulation reference signal (DMRS) ports and the at least two TCI states for the reception of the first set of PDSCHs.

15. The UE of claim 13, wherein to receive the at least one DCI scheduling the UE to receive the first set of PDSCHs and to transmit the PUCCH, the at least one processor is configured to cause the UE to receive at least two DCIs, wherein each of the at least two DCIs schedules the UE to receive a corresponding subset of the first set of PDSCHs and indicates a respective TCI state of the at least two TCI states, wherein each of the at least two DCIs schedules the UE to transmit the PUCCH carrying the one or more HARQ feedbacks corresponding to the corresponding subset of the first set of PDSCHs.

16. A processor for wireless communication, comprising:
at least one controller coupled with at least one memory and configured to cause the processor to:
receive, from a base station (BS), at least one downlink control information (DCI) scheduling the UE to receive a first set of physical downlink shared channels (PDSCHs) associated with at least two transmission configuration indication (TCI) states and to transmit a physical uplink control channel (PUCCH);
receive, from the BS, a second set of PDSCHs and generating one or more hybrid automatic repeat request (HARQ) feedbacks corresponding to the second set of PDSCHs;
determine an uplink (UL) transmission (Tx) beam of at least two UL Tx beams, wherein the determined UL Tx beam is associated with a sensing beam where listen-before-transmit (LBT) procedures generate a success result; and
transmit, to the BS, the PUCCH carrying the one or more HARQ feedbacks corresponding to the second set of PDSCHs with the determined UL Tx beam.

17. A base station (BS) for wireless communication, comprising:
at least one memory; and
at least one processor coupled with the at least one memory and configured to cause the BS to:
transmit, to a user equipment (UE), at least one downlink control information (DCI) scheduling the UE to receive a first set of physical downlink shared channels (PDSCHs) associated with at least two transmission configuration indication (TCI) states and to transmit a physical uplink control channel (PUCCH);
transmit, to the UE, a second set of PDSCHs and generating one or more hybrid automatic repeat request (HARQ) feedbacks corresponding to the second set of PDSCHs; and
receive, from the UE, the PUCCH carrying the one or more HARQ feedbacks corresponding to the second set of PDSCHs with a determined uplink (UL) transmission (Tx) beam.

18. The BS of claim 17, wherein the at least one processor is configured to cause the BS to perform listen-before-transmit (LBT) procedures, and wherein the determined UL Tx beam is associated with a sensing beam where the LBT procedures generate a success result.

19. The BS of claim 17, wherein the at least one DCI indicates at least two groups of demodulation reference signal (DMRS) ports and the at least two TCI states for the first set of PDSCHs.

20. The BS of claim 17, wherein at least two DCIs schedules the UE to transmit the PUCCH carrying the one or more HARQ feedbacks corresponding to a subset of the first set of PDSCHs.
